(19) United States
(12) Patent Application Publication
(10) Pub. No.: US 2024/0426205 A1
(43) Pub. Date: Dec. 26, 2024

(54) DETERMINING STRESS AND STRAIN OF A CONDUIT

(71) Applicant: Baker Hughes Holdings LLC, Houston, TX (US)

(72) Inventor: Inessa Lvovna Yablonskikh, Seaton Delaval (GB)

(21) Appl. No.: 18/680,584

(22) Filed: May 31, 2024

Related U.S. Application Data
(60) Provisional application No. 63/509,387, filed on Jun. 21, 2023.

(51) Int. Cl. E21B 47/007; G01L 5/169

(52) U.S. Cl. CPC E21B 47/007; G01L 5/169

(57) ABSTRACT

Data characterizing a strain of a conduit is received from a strain measuring tool. Data characterizing a stress of the conduit is received from a stress measurement tool. A stress-strain state position on a provided stress-strain curve is determined based on the received data characterizing the strain and the received data characterizing the stress. The determined stress-strains state position is then provided.

### CROSS-REFERENCE TO RELATED APPLICATIONS

This application claims the benefit of U.S. Provisional Application No. 63/509,387, filed on Jun. 21, 2023, and which are hereby incorporated herein by specific reference.

### TECHNICAL FIELD

The subject matter described herein relates to method of combining results of separate instruments and measurements to determine predicted stress and strain.

### BACKGROUND

Pipelines, risers, and other long conduits require regular inspections to determine a health of the conduit. Typical inspection measurements include using those from an inspection unit that is capable of capturing information that can be assessed and calculated to provide a strain (stretching, bending, and/or other deflections) of material of the conduit.

### SUMMARY

This disclosure relates to determining stress and strain of a conduit, such as a pipeline.

An example implementation of the subject matter described within this disclosure is a method with the following features. Data characterizing a strain of a conduit is received from a strain measuring tool. Data characterizing a stress of the conduit is received from a stress measurement tool. A stress-strain state position on a provided stress-strain curve is determined based on the received data characterizing the strain and the received data characterizing the stress. The determined stress-strains state position is then provided.

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method.

Aspects of the example implementations, which can be combined with the example implementations alone or in combination with other aspects, include the following. The strain measuring tool comprises an inertial measurement unit (IMU).

Aspects of the example implementations, which can be combined with the example implementations alone or in combination with other aspects, include the following. The stress measurement tool comprises a magnetic anisotropy and permeability system (MAPS).

Aspects of the example implementations, which can be combined with the example implementations alone or in combination with other aspects, include the following. The strain on the conduit is a bending strain at a specified physical location within the conduit.

Aspects of the example implementations, which can be combined with the example implementations alone or in combination with other aspects, include the following. The stress on the conduit is a total stress at a specified physical location within the conduit.

Aspects of the example implementations, which can be combined with the example implementations alone or in combination with other aspects, include the following. The stress on the conduit is comprises a hoop stress and a longitudinal stress at a specified physical location within the conduit.

Aspects of the example implementations, which can be combined with the example implementations alone or in combination with other aspects, include the following. A historic cyclic load on the conduit is determined based on the determined stress-strain state position.

Aspects of the example implementations, which can be combined with the example method alone or in combination with other implementations, include the following. An active portion of strain is determined and an inactive portion of the strain is determined, both based on the received data characterizing the strain and the received data characterizing the stress. The active and inactive portions of the strain are provided.

Aspects of the example implementations, which can be combined with the example implementations alone or in combination with other aspects, include the following. Providing the stress-strain state position includes displaying the stress-strain state position relative to a characteristic stress-strain model for a material of the conduit.

Aspects of the example implementations, which can be combined with the example implementations alone or in combination with other aspects, include the following. Providing the stress-strain state position includes providing data characterizing the stress-strain state position.

### BRIEF DESCRIPTION OF THE FIGURES

These and other features will be more readily understood from the following detailed description taken in conjunction with the accompanying drawings.

FIG. 1 is a flowchart of a method that can be used with aspects of this disclosure;

FIG. 2 is a chart illustrating potential stress-strain state position values based on a measured strain;

FIG. 3 is a chart illustrating potential stress-strain state position values based on a measured stress;

FIG. 4 is a chart illustrating a stress-strain state position value based on a measured stress and measured strain;

FIG. 5 is a block diagram of an example controller that can be used with aspects of this disclosure; and

FIG. 6 is a side cross-sectional view of an example tool string inserted into a conduit to measure stress and strain of the conduit.

### DETAILED DESCRIPTION

Certain embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

Solely measuring a strain of a long conduit, such as a pipe line or riser, does not provide enough information to determine a fitness for service of the long conduit. This is because the strain measurements alone are not enough to determine work hardening, stress relief, or other cyclic loading that has occurred within the conduit. Without such information, active and inactive strain cannot be determined. Such information is valuable in identifying and assessing atypical or unexpected external loading onto the conduit, for example, indicating if a supporting feature has shifted due to a mudslide or earthquake. For a fitness for service statement of a conduit, it is important to understand how much of the strain comes from an intentional construction bend curvature and what is an active strain component caused by external loading, for example, a landslide, an earthquake of some external human activity.

Accordingly, to determine such information, some implementation described herein take a stress measurement with the strain measurement. More specifically, data characterizing a strain of a conduit is received from an inertial measurement unit (IMU) that can be used in Inline Inspection (ILI) systems that can be used for pipeline integrity management. Data characterizing a stress of the conduit is received from an ILI system capable of collecting data that may be interpreted as stress, such as a magnetic anisotropy and permeability system (MAPS). Such a magnetic sensing system is able to determine stress in one or more directions by measuring how magnetic fields are affected by the conduit. A stress-strain state position on a provided stress-strain curve is determined based on the received data characterizing the strain and the received data characterizing the stress. The determined stress-strain state position is then provided.

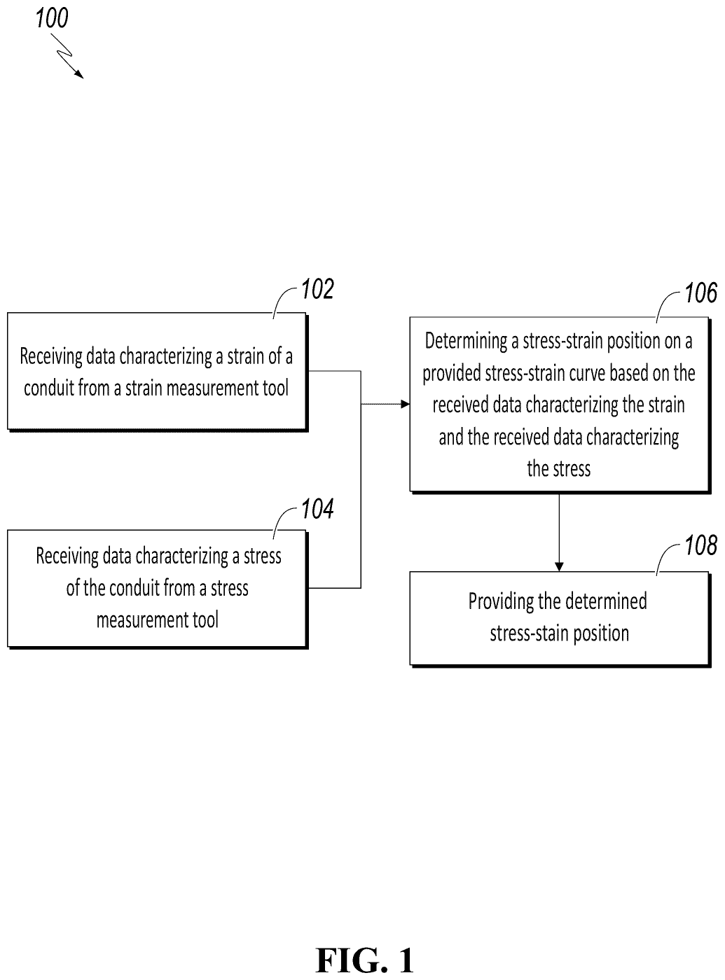

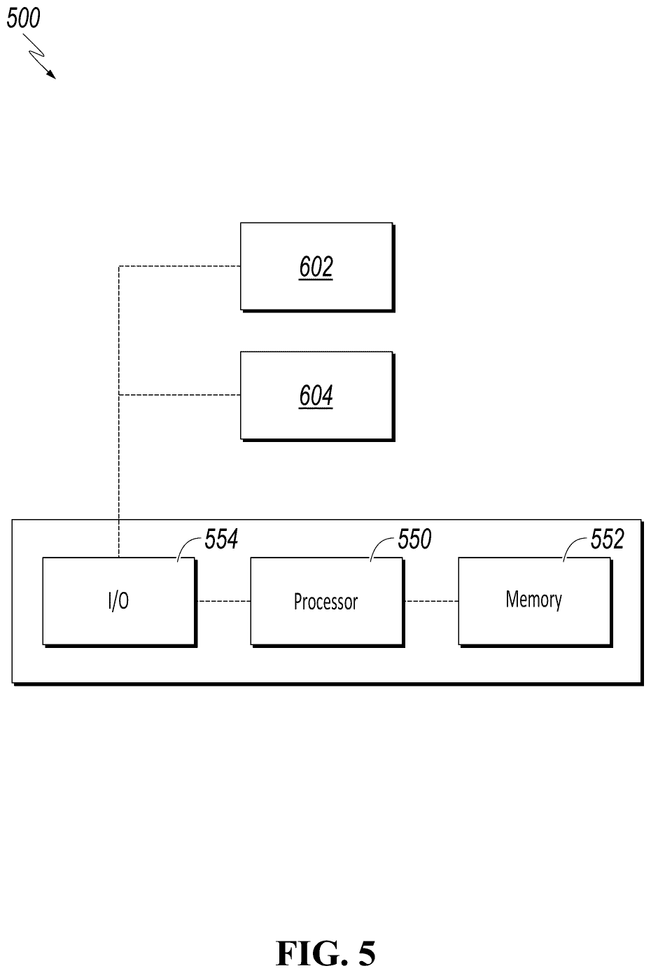

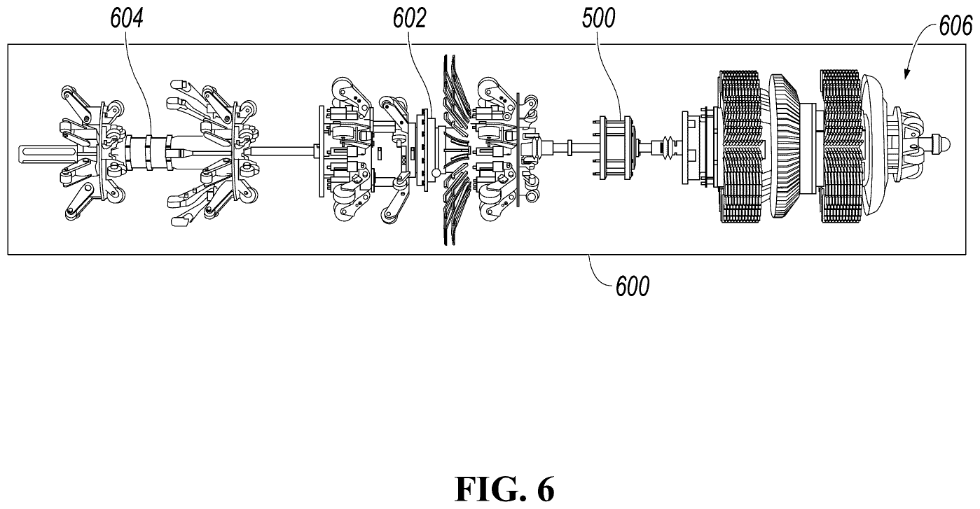

FIG. 1 is a flowchart of a method 100 that can be used with aspects of this disclosure. At 102, data characterizing a strain of a conduit 600 (FIG. 6) is received from a strain measurement device, such as the IMU 602. While primarily described as using data from the IMU 602, other stain measurement devices, such as a caliper measurement unit, can be used without departing from this disclosure. In some implementations, the strain on the conduit 600 is a bending strain at a specified physical location within the conduit 600. Other strain, such as axial strain, hoop strain, and or local strain caused by dents or other discontinuities, can be provided by the strain measurement device without departing from this disclosure. Alternatively or in addition, a global strain or strain in multiple locations can be taken to make similar assessments and determinations as those described within this disclosure. More details on the IMU 602 are described later within this disclosure. An example controller 500, which can perform the method 100 fully or in part, is described later within this disclosure in the context of FIG. 5.

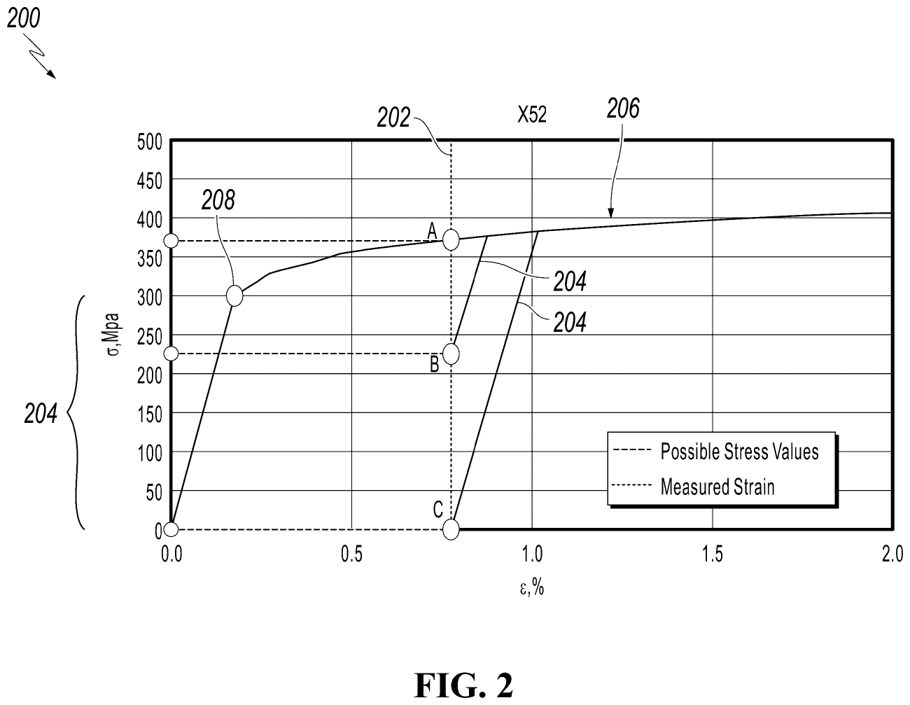

Referring to FIG. 2 in reference to step 102, the chart 200 illustrates potential stress-strain values based on a determined strain as represented by vertical line 202. During load cycling or work hardening, the clastic portion 204 of the stress-strain curve 206 moves to the right. As it is unlikely that the number of load cycles is known, a measured strain has multiple possible stress values that correspond with the measured strain value. For example, point A, point B, and point C in the illustrated FIG. 2.

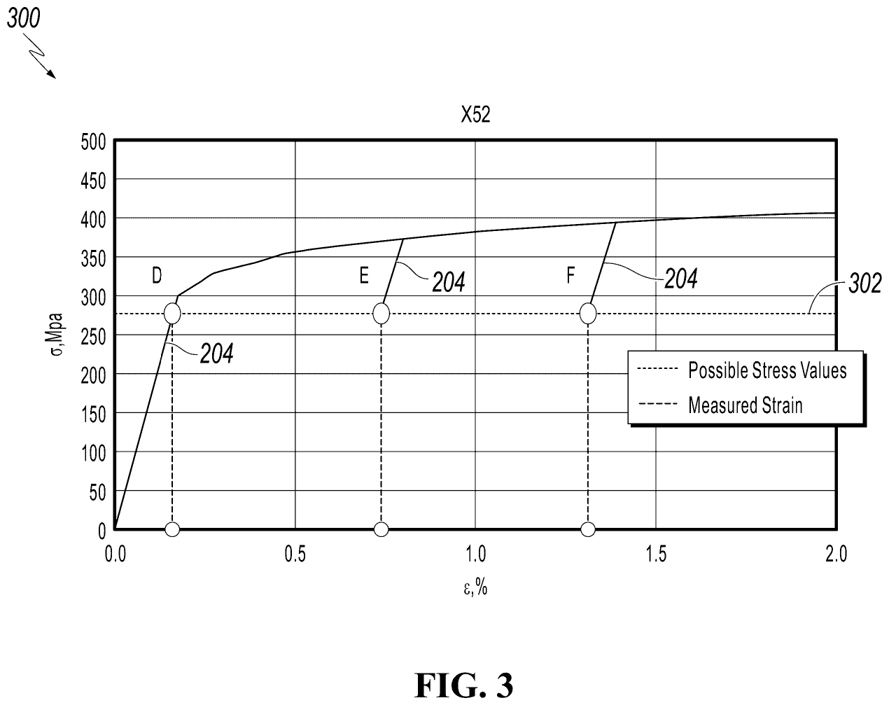

At 104, data characterizing a stress of the conduit is received from a stress sensing system, for example, from the MAPS 604. In some implementations, the stress on the conduit includes a total stress at a specified location within the conduit. While primarily described as using total stress for simplicity, stress measurements can pertain to one or more stress components without departing from this disclosure. For example, hoop stress, radial stress, axial stress, or a combination can be measured, converted into data characterizing such stress, and be received without departing from this disclosure. Alternatively or in addition, a global stress or stress at multiple locations can be taken to make similar assessments and determinations as those described within this disclosure. Referring to FIG. 3 in references to step 104, the chart 300 illustrates potential stress-strain values based on a measured stress as represented by horizontal line 302. Similar to the measured strain described in FIG. 2, the measured stress can correspond to multiple possible strain values, such as points D, E, and F within FIG. 3. While only a handful of clastic portions 204 of the stress-strain curves are illustrated in FIG. 2 and FIG. 3, any number of elastic portions can be present depending on material properties and geometries.

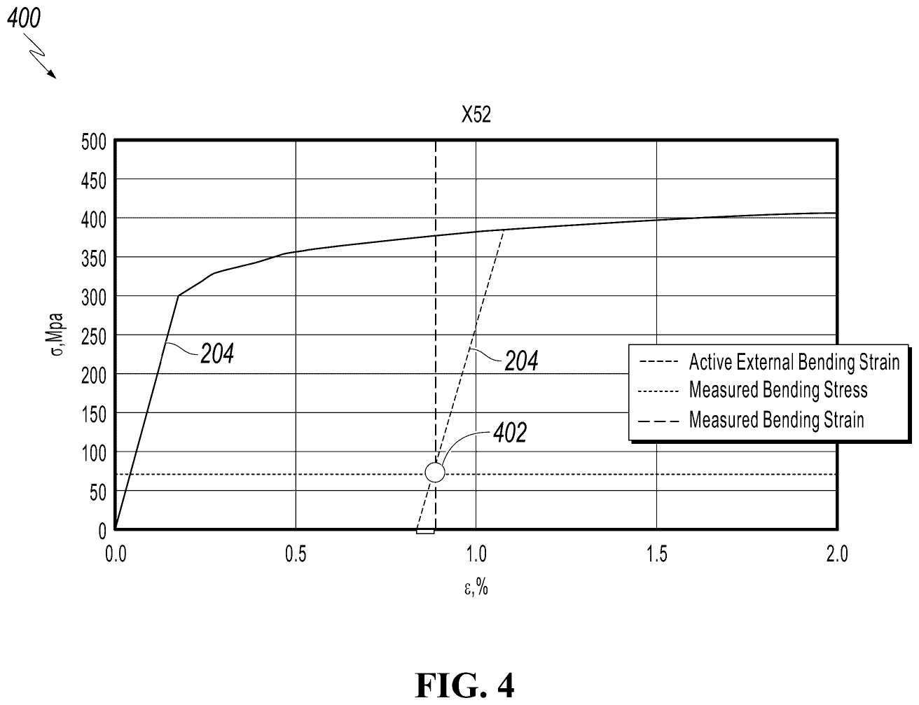

At 106, a stress-strain state position on a provided stress-strain curve is determined based on the received data characterizing the strain and the received data characterizing the stress. Such an example is illustrated in FIG. 4 with the chart 400. Measuring both the stress and the strain with a stress measuring system, such as the MAPS 604, and a bending strain system, such as the IMU 602, respectively, produces a fixed point 402 (shown in FIG. 4) that can be used to determine which elastic portion 204 of the stress strain Curve 206 the conduit 600 is currently experiencing. As the elastic portion is known, the historic cyclic load on the conduit can be determined based on the determined stress-strain state position (fixed point 402). Alternatively or in addition, the stress-strain state position can be used to determine an active portion of the strain and an inactive portion of the strain. An inactive portion of the strain occurs after cyclic loading or work hardening. If the conduit is fully under inactive strain, the stress is substantially zero. Active strain occurs when the stress is not zero. The active strain is the difference between the inactive strain and the measured strain.

At 108, the determined stress-stain position is provided. For example, the stress strain position can be displayed or provided as data characterizing the stress-strain state position. Alternatively or in addition, the historic load cycle, the active portion of the strain, and/or the inactive portion of the strain can be provided in a similar manner.

FIG. 5 illustrates an example controller 500 that can be used with some aspects of the current subject matter. For example, in some embodiments, the controller can execute all or part of the method 100. The controller 500 can, among other things, monitor parameters of a system, send signals to actuate and/or adjust various operating parameters of such systems. Examples of such a system are described later within this disclosure. As shown in FIG. 5, the controller 500 can include one or more processors 550 and non-transitory computer readable memory storage (e.g., memory 552) containing instructions that cause the processors 550 to perform operations. The processors 550 are coupled to an input/output (I/O) interface 554 for sending and receiving communications with components in the system, including, for example, the IMU 602, the MAPS 604, or similar systems. In certain instances, the controller 500 can additionally communicate status with and send actuation and/or control signals to one or more of the various system components (including, for example, a winch, driving fluid, or tractor) of the system, as well as other sensors (e.g., pressure sensors, temperature sensors, vibration sensors and other types of sensors) that provide signals to the system.

FIG. 6 is a side cross-sectional view of an example ILI 606 inserted into the conduit 600 to measure stress and strain of the conduit 600. The ILI 606 includes a stress measurement unit, such as the MAPS 604, and a strain measurement system, such as the IMU 602. Alternatively or in addition, separate ILIs with the MAPS 604 on a first ILI and the IMU 602 on a second, separate ILI can be used without departing from this disclosure. In some implementations, a tractor system can be included with the ILI 606 to convey the ILI 606 through the conduit. Alternatively or in addition, a winch can be used to convey the ILI 606 through the conduit. Alternatively or in addition, the fluid within the conduit can be used to convey the ILI 606 through the conduit. The conduit itself is often metallic, but the principles described herein can be similarly applied to other conduits with varying materials.

In some embodiments, source code can be human-readable code that can be written in program languages such as python, C++, etc. In some embodiments, computer-executable codes can be machine-readable codes that can be generated by compiling one or more source codes. Computer-executable codes can be executed by operating systems (e.g., Linux, windows, mac, etc.) of a computing device or distributed computing system. For example, computer-executable codes can include data needed to create runtime environment (e.g., binary machine code) that can be executed on the processors of the computing system or the distributed computing system.

Other embodiments are within the scope and spirit of the disclosed subject matter. For example, the method of generating consolidate dataset described in this application can be used in facilities that have complex machines with multiple operational parameters. Usage of the word “optimize” /“optimizing” in this application can imply “improve” /“improving.”

Certain embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an embodiment of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving data characterizing a strain of a conduit from a strain measuring tool;
receiving data characterizing a stress of the conduit from a stress measurement tool;
determining a stress-strain state position on a provided stress-strain curve based on the received data characterizing the strain and the received data characterizing the stress;
providing the determined stress-stain position.

2. The method of claim 1, wherein the strain measuring tool comprises an inertial measurement unit (IMU).

3. The method of claim 1, wherein the stress measurement tool comprises a magnetic anisotropy and permeability system (MAPS).

4. The method of claim 1, wherein the strain on the conduit is a bending strain at a specified physical location within the conduit.

5. The method of claim 1, wherein the stress on the conduit is a total stress at a specified physical location within the conduit.

6. The method of claim 1, further comprising:
determining a historic cyclic load on the conduit based on the determined stress-strain state position;
providing the historic cyclic load on the conduit based on the determined stress-strain state position.

7. The method of claim 1, further comprising:
determining an active portion of strain based on the received data characterizing the strain and the received data characterizing the stress;
determining an inactive portion of strain based on the received data characterizing the strain and the received data characterizing the stress;
providing the active and inactive portions of strain.

8. The method of claim 1, wherein providing the stress-strain state position comprises displaying the stress-strain state position relative to a characteristic stress-strain model for a material of the conduit.

9. The method of claim 1, wherein providing the stress-strain state position comprises providing data characterizing the stress-strain state position.

10. A system comprising:
at least one data processor; and
non-transitory memory storing instructions, which, when executed by the at least one data processor causes the at least one data processor to perform operations comprising:
receiving data characterizing a strain of a conduit from an inertial measurement unit (IMU);
receiving data characterizing a stress of the conduit from a stress measurement tool;
determining a stress-strain state position on a provided stress-strain curve based on the received data characterizing the strain and the received data characterizing the stress;
providing the determined stress-stain position.

11. The system of claim 10, wherein the stress measurement tool comprises a magnetic anisotropy and permeability system (MAPS).

12. The system of claim 10, wherein the strain on the conduit is a bending strain at a specified physical location within the conduit.

13. The system of claim 10, wherein the stress on the conduit is a total stress at a specified physical location within the conduit.

14. The system of claim 10, wherein the instructions further cause the at least one data processor to perform operations comprising:
determining a historic cyclic load on the conduit based on the determined stress-strain state position;
providing the historic cyclic load on the conduit based on the determined stress-strain state position.

15. The system of claim 10, wherein the instructions further cause the at least one data processor to perform operations comprising:
determining an active portion of strain based on the received data characterizing the strain and the received data characterizing the stress;
determining an inactive portion of strain based on the received data characterizing the strain and the received data characterizing the stress;
providing the active and inactive portions of strain.

16. The system of claim 10, wherein providing the stress-strain state position comprises displaying the stress-strain state position relative to a characteristic stress-strain model for a material of the conduit.

17. The system of claim 10, wherein providing the stress-strain state position comprises providing data characterizing the stress-strain state position.

18. A non-transitory computer readable memory storing instructions which, when executed by at least one data processor forming part of at least one computing system, causes the at least one data processor to perform operations comprising:
receiving data characterizing a strain of a conduit from an inertial measurement unit (IMU);
receiving data characterizing a stress of the conduit from a stress measurement tool;
determining a stress-strain state position on a provided stress-strain curve based on the received data characterizing the strain and the received data characterizing the stress;
providing the determined stress-stain state position.

19. The non-transitory computer readable memory of claim 18, wherein the stress measurement tool comprises a magnetic anisotropy and permeability system (MAPS).

20. The non-transitory computer readable memory of claim 18, wherein the strain on the conduit is a bending strain at a specified physical location within the conduit.

21. The non-transitory computer readable memory of claim 18, wherein the stress on the conduit is comprises a hoop stress and a longitudinal stress at a specified physical location within the conduit.

22. The non-transitory computer readable memory of claim 18, wherein the instructions further cause the at least one data processor to perform operations comprising:
determining a historic cyclic load on the conduit based on the determined stress-strain state position;
providing the historic cyclic load on the conduit based on the determined stress-strain state position.

23. The non-transitory computer readable memory of claim 18, wherein the instructions further cause the at least one data processor to perform operations comprising:
determining an active portion of strain based on the received data characterizing the strain and the received data characterizing the stress;
determining an inactive portion of strain based on the received data characterizing the strain and the received data characterizing the stress;
providing the active and inactive portions of strain.

24. The non-transitory computer readable memory of claim 18, wherein providing the stress-strain state position comprises displaying the stress-strain state position relative to a characteristic stress-strain model for a material of the conduit.

25. The non-transitory computer readable memory of claim 18, wherein providing the stress-strain state position comprises providing data characterizing the stress-strain state position.
